(19) United States
(12) Patent Application Publication
(10) Pub. No.: US 2017/0061392 A1
(43) Pub. Date: Mar. 2, 2017

(54) AUTOMATED EVENT CREATION FOR TALENT-VENUE PAIRINGS

(71) Applicant: ThreeToParty, Inc., Chula Vista, CA (US)

(72) Inventors: Adolfo Meza-Guinea, Chula Vista, CA (US); Robert Hugh Jenkins, San Diego, CA (US)

(21) Appl. No.: 15/255,877

(22) Filed: Sep. 2, 2016

Related U.S. Application Data
(60) Provisional application No. 62/213,129, filed on Sep. 2, 2015.

(51) Int. Cl. G06Q 10/10; G06Q 50/12

(52) U.S. Cl. CPC G06Q 10/1095; G06Q 50/12

(57) ABSTRACT

Automated event creation for talent-venue pairings. In an embodiment, a plurality of talent profiles and venue profiles are created, each comprising information for a talent or venue, respectively. Information in one or more talent profiles is compared to information in one or more venue profiles to identify at least one match between a talent and a venue. A representation of an event is generated based on the at least one match, wherein the event comprises at least one action performed by the talent at the venue. One or more potential patrons of the event are identified and invited to the event.

### CROSS-REFERENCE TO RELATED APPLICATIONS

This application claims priority to U.S. Provisional Patent App. No. 62/213,129, filed on Sep. 2, 2015, and titled “Systems and Methods for Pairing Chefs, Musicians, Bars, Restaurants and Customers to Create Exclusive Events,” the entirety of which is hereby incorporated herein by reference.

### BACKGROUND

Field of the Invention

The embodiments described herein are generally directed to the fully-automated or semi-automated creation of events, and, more particularly, events featuring talent (e.g., chef and/or musician), a venue, and patrons.

Related Art

In the restaurant industry, successful bars and restaurants are created through a combination of multiple features, including the cuisine, chef, location, ambiance, availability of live music, price, menu, customer service and reputation. However, even the most successful bars and restaurants often need to continuously update their menus, ambiance, decor, chefs, and other features to maintain interest among their customer base. Many bars and restaurants fail due to their inability to update these features, in particular the menus, cuisine, chefs, and ambiance.

An even more basic problem is the need for bars and restaurants to drive business consistently every day of the week. Certain weeknights are notoriously slow for bars and restaurants, and the bars and restaurants usually respond with specials or discounts only on those nights. However, consumers eventually tire of the same special offers after a long period of time, as the offers are simply no longer “special,” but mundane.

A further challenge is the basic competition between restaurants for the same customer. The techniques used to fill tables on slow nights involves one strategy, while the techniques used to fill tables on a popular dining night—such as Valentine's Day or New Year's Eve—may involve a completely different strategy. Further still is the challenge to remain relevant, as the restaurant industry constantly goes through changing trends in food or cuisine. Many restaurants can do nothing but watch while newer, trendier restaurant concepts spring up and steal business.

The food industry as a whole has seen a recent resurgence in interest, from an increased emphasis on fresh, quality ingredients to the increased visibility of chefs and restaurants, due in part to the use of social media. The use of online reviews alone has required the restaurant industry to focus on a subset of customers whose reviews command more respect and attention than a seasoned food critic. A well-executed social media campaign can drive business to a restaurant indefinitely, as customers are relying more and more on online content to provide them with information on the best restaurants and special events. Many customers create online profiles that provide valuable insight into dining trends and preferences. However, aggregating and analyzing the massive amount of online content is a challenge.

Therefore, it is desirable to develop systems and methods to utilize online content and identify trends to create and maintain interest in a bar and/or restaurant.

Similarly, it is desirable to develop systems and methods to utilize online content and identify trends to create and maintain interest in a musician and/or chef.

### SUMMARY

In an embodiment, a method is disclosed. The method comprises using at least one hardware processor to: create a plurality of talent profiles, wherein each talent profile comprises information for a talent; create a plurality of venue profiles, wherein each venue profile comprises information for a venue; compare information in one or more of the plurality of talent profiles to information in one or more of the plurality of venue profiles to identify at least one match between a first talent and a first venue; generate a representation of an event based on the at least one match between the first talent and the first venue, wherein the event comprises at least one action performed by the first talent at the first venue; identify one or more potential patrons of the event; and invite the one or more potential patrons to the event.

In another embodiment, a system is disclosed. The system comprises: at least one hardware processor; and at least one software module configured to, when executed by the at least one hardware processor, create a plurality of talent profiles, wherein each talent profile comprises information for a talent, create a plurality of venue profiles, wherein each venue profile comprises information for a venue, compare information in one or more of the plurality of talent profiles to information in one or more of the plurality of venue profiles to identify at least one match between a first talent and a first venue, generate a representation of an event based on the at least one match between the first talent and the first venue, wherein the event comprises at least one action performed by the first talent at the first venue, identify one or more potential patrons of the event, and invite the one or more potential patrons to the event.

In another embodiment, a non-transitory computer-readable medium is disclosed. The non-transitory computer-readable medium has instructions stored thereon, wherein the instructions, when executed by a processor, cause the processor to: create a plurality of talent profiles, wherein each talent profile comprises information for a talent; create a plurality of venue profiles, wherein each venue profile comprises information for a venue; compare information in one or more of the plurality of talent profiles to information in one or more of the plurality of venue profiles to identify at least one match between a first talent and a first venue; generate a representation of an event based on the at least one match between the first talent and the first venue, wherein the event comprises at least one action performed by the first talent at the first venue; identify one or more potential patrons of the event; and invite the one or more potential patrons to the event.

Embodiments described herein provide systems, methods, and media for matching talent (e.g., chefs and/or musicians) restaurants, bars and customers to create customized, exclusive music and/or dining events. The system utilizes complex profiles and schedules of restaurants, bars, talent, and customers to create suggested pairings that manifest into an exclusive, one-time dining and/or live music experience where the paired talent and bar or restaurant create a unique menu, musical performance, etc. based on their collective skill sets, which can then be marketed to a targeted set of customers. The system may include one or more computing devices where the talent, restaurant, bar, and/or customer each interact within an application or website to create a profile of their skills, interests, capabilities, preferences, and/or availability, which is then stored in and analyzed by a remote server to produce recommended matches. Ratings and reviews may also be utilized to determine the recommended matches. Once a match is created, additional profile information is used to guide the talent and bar or restaurant in creating a menu based on the capabilities, supplies, and/or capacity of the bar or restaurant and talent. The menu is then broadcast to interested customers who, based on their membership level or participation, may buy tickets or book reservations in advance.

Other features and advantages of the present invention will become more readily apparent to those of ordinary skill in the art after reviewing the following detailed description and accompanying drawings. While the talent will be primarily referred to herein as chefs or musicians, it should be understood that embodiments may be adapted to suit other types of talent.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for creating and matching profiles of chefs, musicians, restaurants, bars, and customers to create exclusive events, according to an embodiment of the invention;

FIG. 2 is a flow diagram illustrating an example process for matching chefs, musicians, restaurants, bars and customers to create the exclusive events, according to an embodiment of the invention;

FIG. 3 is a block diagram illustrating an example wired or wireless processor enabled device that may be used in connection with various embodiments described herein; and

FIG. 4 is a flow diagram illustrating an example process for multivariate statistical analysis that may be used in connection with various embodiments described herein.

### DETAILED DESCRIPTION

Certain embodiments disclosed herein provide for matching chefs, musicians, restaurants, bars, and customers based on profile information to create exclusive events. For example, one method disclosed herein provides for matching profile information of chefs and restaurants to create and plan an exclusive, one-time dining event, including a customized menu, which is then broadcast to a target set of customers who are interested in the particular match. The chefs, restaurants, and customers utilize memberships to obtain particular benefits, and provide reviews and rankings that influence future matches.

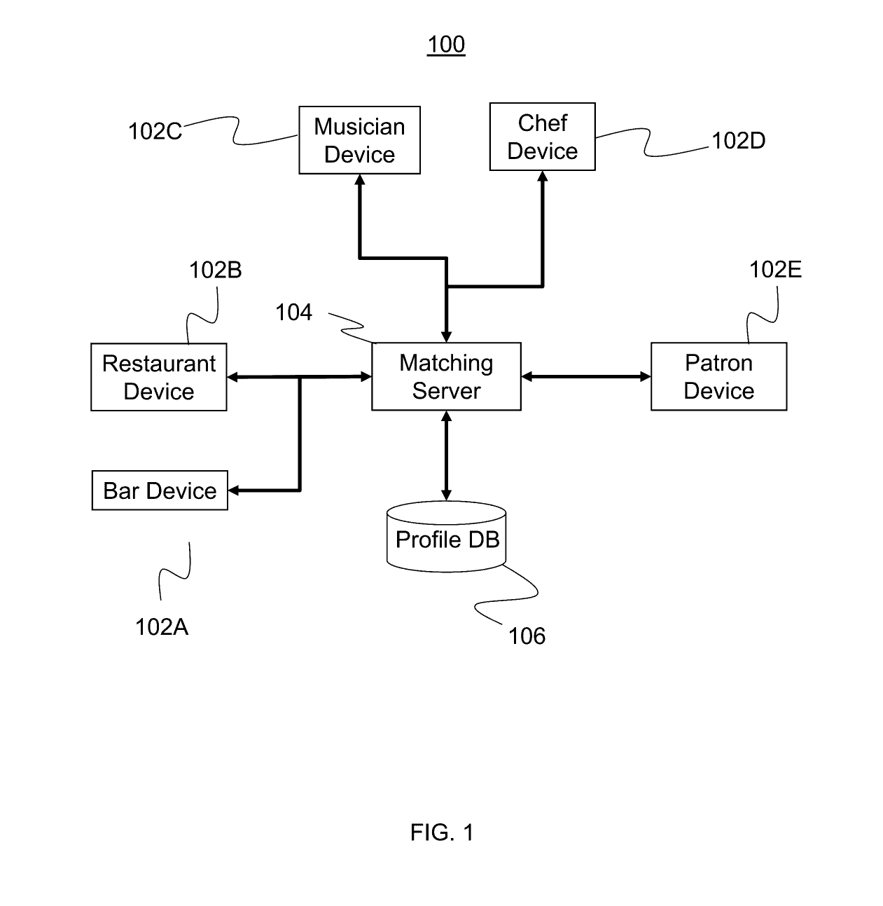

One embodiment of a system 100 for creating and matching profiles of musicians, chefs, bars, restaurants, and customers is illustrated in FIG. 1, where each participant uses a computing device 102—shown here as a bar device 102A, restaurant device 102B, musician device 102C, chef device 102D, and patron device 102E—to interact with an application on the device, a matching server 104 or website accessible on the device and hosted by the matching server 104 to create and maintain their individual profile. The profiles may then be stored in a profile database 106 of the matching server 104 connected with the computing devices via a network. The matching server 104 may be configured with software programmed to analyze the profile information and suggest, schedule, and plan matches between the musicians, chefs, bars, restaurants and customers. The matching server 104 may also be configured to generate user interfaces for display on the participants' computing devices 102, as well as to transmit and receive information between the devices 102.

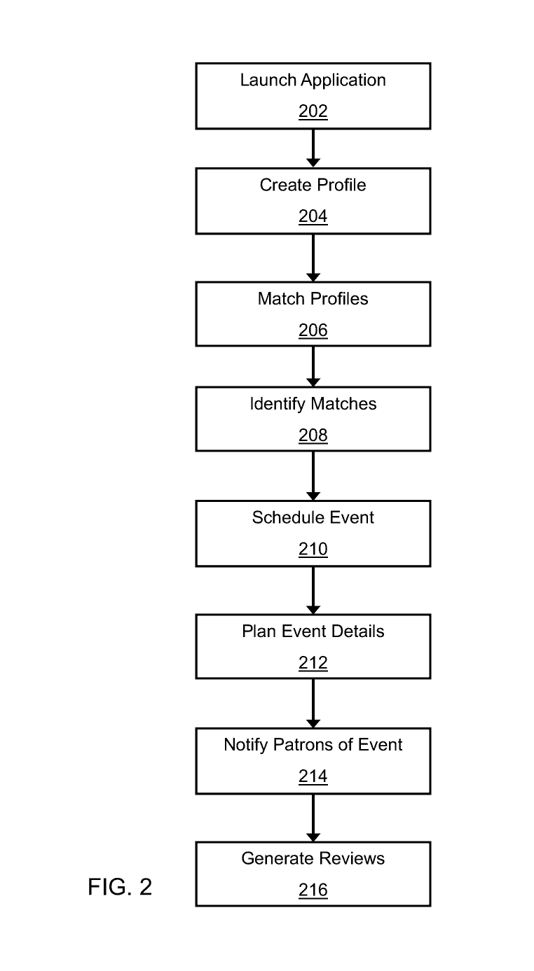

FIG. 2 illustrates one embodiment of a method for matching musicians, chefs, bars, restaurants, and customers, according to one embodiment of the invention. In a first step, the user on the computing device—be it the bar, restaurant, musician, chef, or patron—launches the application (202) and creates a profile (204). Information in the profiles is then used to match musicians, chefs, bars, restaurants, and patrons (206), identify the matches (208) to potential matching users and schedule an event (210) with the matching musician and/or chef and bar or restaurant. The musician and/or chef and bar or restaurant then plan the event details (212) through the customized user interface, and patrons are notified of the event (214). Once the event is complete, the patrons (and the bar or restaurant and musician and/or chef) can generate reviews of the event and participants (216).

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

I. Profiles

In order to create an event, each of the participants will maintain a profile within the system. The profile for the restaurant, bar, chef, musician, and customer all contain unique profile categories based on the type of information needed to create a match. The profiles may be created by a user on a computing device, as described above in FIG. 1, and will be stored within the system in separate or combined databases or database tables which separate the categories for matching.

In one embodiment, a restaurant profile may include information on the restaurant name, location, cuisine, price range, seating capacity, kitchen equipment, current chef and staffing capabilities, supplies, and availability for dining events. Reviews and ratings of the restaurant may also be included in the restaurant profile, and may be obtained from third party sources or from customer reviews and rankings in addition to the restaurant's own submitted rankings and ratings. The restaurant profile may also include information on a desired dining event, such as a desired type of cuisine, chef or menu. For example, a restaurant can select a particular chef—either from a list of all chefs or a list of chefs available for a particular date.

Similarly, a chef profile may include information on the chef such as the chef's name, location, training, experience, culinary skills, preferred cuisine, and availability. The chef may link his or her online calendar with an availability calendar run by the inventive system in order to better track availability and scheduled events. The chef may also link his or her profile to a third party review or rankings site, or even a social media profile page to help build followers of the chef. As with the restaurant profile, the chef profile may include the chef's preferences for a dining event, such as a city, restaurant, type of cuisine, or menu that the chef would like to work on. In one embodiment, the chef may create a sample menu of types of dishes that he or she is interested in serving in order to gain more interest from a particular restaurant or customer base.

In another embodiment, a bar profile may include information on the bar name, location, cuisine availability, live-music availability, price range, seating capacity, kitchen equipment, current chef, current liquor offerings, current staffing capabilities, supplies, and availability for dining and live music events. Reviews and ratings of the bar may also be included in the bar profile, and may be obtained from third party sources or from customer reviews and rankings in addition to the bar's own submitted rankings and ratings. The bar profile may also include information on a desired event, such as a desired type of cuisine, music genre, chef, musician, or menu. For example, a bar can select a particular musician and/or chef—either from a list of all chefs and/or musicians or a list of chefs and/or musicians available for a particular date.

Similarly, a musician profile may include information on the musician such as the musician's name, band name, location, training, experience, skills, music genre, and availability. The musician may link his or her online calendar with an availability calendar run by the inventive system in order to better track availability and scheduled events. The musician may also link his or her profile to a third party review or rankings site, or even a social media profile page to help build followers of the musician or band. As with the bar profile, the musician profile may include the musician's preferences for an event, such as a city, bar, music genre, that the musician would like to perform for.

A customer profile is utilized more for identifying potential customers for an existing match as much as it is used for determining an actual match for a dining event. However, the customer profile will still include the customer's name, location, but primarily include a list of favorites, including cuisine, price range, restaurants, chefs menu items. Furthermore, the customer may link their profile to a third party site, such as a restaurant review site like Yelp!® or their social media profile. The system may then incorporate their reviews and ratings on third party sites when determining particular matches that the customer may enjoy. The customer may also include their own suggestions for events between restaurants, bars, musicians and chefs, either at a categorical level (such as suggesting a sushi chef for a French restaurant) or at an individual level (such as suggesting their favorite celebrity chef or band for their favorite local restaurant or bar).

The users can continuously update their profiles, which may then result in new recommended matches. The restaurant, bar, chef, musician and customer profiles will also be updated continuously to track their participation in events, which can be used to generate new rankings and reviews of the dining event and as a rewards system for frequent users.

In addition to the users' own profiles, the system may produce a profile for each restaurant, bar, chef, musician or customer based on its own criteria and information. More specifically, the system may incorporate reviews and assessments of the participating chefs, musicians, bars and restaurants to ensure that they possess the skills, experience and capabilities advertised on their profiles. This internal profile information may be incorporated into the participants' reviews, or be reflected with a special certification that will help the participant obtain a better match for an event.

Another aspect of the profile for each participant is a membership level, which may be offered to each type of participant based on a level of experience or for a price. For example, a highly rated restaurant, bar, musician, or chef may be provided a complimentary membership, while a new restaurant or novice chef or musician may need to pay to join and participate. For all participants, a level of membership will provide varying levels of rights and privileges. Higher level restaurants, bars, musicians and chefs may receive exclusive match recommendations with other high level members, and correspondingly, high level customers may receive exclusive opportunities to attend dining events with the high level restaurants, bars, musicians, and chefs. If the membership level is based on experience or ratings, the membership level may change depending on the ratings and reviews or amount of participation in events.

II. Matching

Once the restaurant, bar, chef, musician, and customer profiles are created, the system uses the information in the profiles to create recommendations for matches, using basic matching techniques and complex comparative algorithms to identify similarities between individual and varying categories. Each recommended match can also include a ranking or score for the match that indicates a predicted level of success for the match, based on a number of similar categories or the strength of a match in a few key categories that may be weighted to have more influence on the recommended matches (such as geographic location) The ranking or score may be utilized by the system to only produce results above a certain score, or by an individual restaurant, bar, chef, musician or customer to use as a custom threshold for selecting a match. The ranking or score may be published along with the event to advertise the desirability of the event.

Each of the categories of the profiles that are evaluated may be given a weight that corresponds to a perceived value of that category. As mentioned above, location may have a high weight value because of the difficulty of arranging for a matched chef or customer to travel to a different location for a dining event. Additional weights may be based on the credibility or reputation of a chef, musician, bar or restaurant, so that a highly-rated chef and/or musician who requests an event at a highly-rated bar or restaurant is given a large weight value, while a novice or inexperienced chef and/or musician requesting a highly-rated bar or restaurant is given a low weight value.

In one embodiment, the recommended matches may be based on availability of one or more of the participants. For example, if a chef inputs into their calendar profile that they will be traveling to a particular city on a particular date, the system may utilize this information to suggest new recommended matches for restaurants in that city that the chef may be interested in. Customers may also receive similar calendar and location-based suggestions. Restaurants may also receive location-based suggestions for traveling chefs or even traveling restaurants, such as a food truck.

Similarly, if a musician inputs into their calendar profile that they will be traveling to a particular city on a particular date, the system may utilize this information to suggest new recommended matches for bars and/or restaurants in that city that the musician may be interested in.

Once recommended matches are generated, the participants are notified and given information about the match or matches. If multiple matches are recommended, the participants may be given a list in order of a determined score or ranking and details of how the ranking or score was calculated so the participants can determine on their own if the ranking or score is reflective of a good match.

Regardless of whether the availability and calendar information is used to select a recommended match, the next step in selecting a recommended match is using a calendar interface to determine a date for a dining event to take place. If either the chef, musician, bar, or restaurant previously selected a specific date and the other party accepted, the event can be immediately scheduled. Otherwise, the participants will utilize the user interface to select and agree upon a certain date. The calendar interface will provide for the musician, chef, bar, or restaurant to select dates or date and time ranges when they are interested in participating, not available, open or booked, including recurring availabilities. Additional options include suggesting a type of cuisine desired for a certain night, and/or a music genre. The user may change the status of any one day or time slot, but may need to confirm the change if it requires the restaurant and/or bar to cancel reservations. When a request is sent from one party to another, a notification is provided to the receiving party of the request.

When a match is agreed upon by a restaurant and a chef, a dining event is created, and the system will look for customer matches for that particular dining event. The customer matches may be based simply on a location of the dining event in comparison with the location of the customers, but can of course also be based on matches with the detailed customer profile information, such as the customer's favorite chefs, restaurants, cuisine, price range, etc. As mentioned above, the membership level of the customer may also be utilized to offer certain type of matches to certain levels of members.

When a match is agreed upon by a bar or restaurant and a musician, an event is created, and the system will look for customer matches for that particular event. The customer matches may be based simply on a location of the event in comparison with the location of the customers, but can of course also be based on matches with the detailed customer profile information, such as the customer's favorite musicians, restaurants, cuisine, music genre, price range, etc. As mentioned above, the membership level of the customer may also be utilized to offer certain type of matches to certain levels of members.

III. Event Planning

When a dining event is agreed upon by a restaurant and a chef, the system provides additional tools to plan the event. These tools may include a menu generator tool which helps the chef prepare a menu for the dining event. A graphical user interface (GUI) may be provided with a list of ingredients, nutritional values, portions, restaurant equipment, staff experience, seating capacity, desired price points, and revenue. The chef may even be able to book equipment and tools so the staff of the restaurant knows what needs to be done in preparation for the dining event.

When a music event is agreed upon by a restaurant or bar and a musician and/or chef, the system provides additional tools to plan the event. These tools may include a list of required equipment, staff experience, seating capacity, desired price points, and revenue.

On the bar and restaurant side, the bar or restaurant may be provided with a list of needed ingredients, staff and other needed items that will help the bar or restaurant identify what is needed for the event. The list may be integrated with the restaurant's existing supply chain software to automatically upload the information to vendors and suppliers in preparation for the event.

In one embodiment, the system includes a communication tool that allows the participants in the dining event to easily communicate with each other for planning and marketing of the event. This includes direct communication and sharing of contact information between the chef and restaurant, as well as marketing messages that can be sent out to potential customers to invite them to the event or allow them to book reservations, buy tickets, review the event, etc. The system may provide the chef and restaurant with marketing materials and information to post to social media and other profiles to promote the event internally within the system and externally to third party sites.

Similarly, the system includes a communication tool that allows the participants in an event to easily communicate with each other for planning and marketing of the event. This includes direct communication and sharing of contact information between the musician and bar, as well as marketing messages that can be sent out to potential customers to invite them to the event or allow them to book reservations, buy tickets, review the event, etc. The system may provide the musician and restaurant with marketing materials and information to post to social media and other profiles to promote the event internally within the system and externally to third party sites.

IV. Test Kitchen

In one embodiment, a restaurant may deem itself a dining event test kitchen, where the restaurant continuously provides only matched dining events. The restaurant may be given a specialized title and category within the system to indicate its special status, and could be given the same name across different locations to create a brand that helps to tie the test kitchen matching concept into a particular name.

In another embodiment, the “test kitchen” title may refer to a special type of dining event where a novice chef without a significant amount of experience or reviews may be invited to participate. The novice chef may be invited along with other novice chefs or experienced chefs to participate in a competition amongst the customers to determine which chef prepared the best menu or menu items. These results may be incorporated into the chef and restaurant profile.

V. Reviews and Rankings

As previously mentioned, existing rankings and reviews of musician, chefs, bars and restaurants, such as those from third party services, may be utilized in the profiles of the participants. In addition, the participants can generate reviews and rankings within the system that are utilized to influence future matches and determine certain membership privileges for participants. For example, a restaurant or chef which hosts or participates in a certain number of dining events and which receives a certain number of positive reviews may achieve a special review or membership status, which will then allow the participant to obtain preferred matches with other preferred members. Similarly, customers may also obtain special membership levels based on the number of events they participate in, and then receive special invitations to exclusive events or advanced notifications of certain events, greater influence over suggested matches, etc.

VI. User Applications

Various examples of the matching system and its application to restaurants, bars, musicians, chefs and customers are described in the tables below. The examples describe additional features and user interfaces available that implement the matching, scheduling, event planning and reviewing described above.

As a Talent (i.e. chef or musician)

| I want to . . . | So that . . . | |
|---|---|---|
| <what> | <why> | It is expected that . . . <acceptance criteria> |
| Register for | I can start | Enter my e-mail, address, social security number and |
| an account | booking gigs | documentation necessary for tax and payment information. |
| | with bars | Enter my credentials, upload a picture, upload a resume, |
| | and/or | LinkedIn profile, Facebook page, etc. so this information can |
| | restaurants | be used to present profiles to patrons and restaurants. |
| | | Add a link to my website. Provide references from school, |
| | | restaurants, bars, previous accomplishments, etc. Chef and |
| | | musician accounts may have to be verified. |
| Upload my | Bars and | musicians and/or chefs can select dates or date ranges from a |
| availability | restaurants | calendar in order to mark the dates as “Interested”, “Not |
| to my | can contact | available”, “open” or “booked” |
| account | me for | access calendar from “badges/notifications” so that the |
| | booking | musician and/or chef can see on the calendar a date when he |
| | | is being invited to present. |
| | | User can change status of any day, unless it is marked as |
| | | “booked” in which case there will have to be communication |
| | | with bar, restaurant, musician and patrons (i.e. cancellation |
| | | policy) |
| Open | I can book a | access my calendar from the alerts tab. If I am responding to |
| availability | night based | an invite, it should already prompt me with information about |
| on my | on an invite | the event matching process. |
| calendar | from a | |
| based on a | bar or | |
| bar or | restaurant. | |
| restaurant | | |
| invite | | |
| See bars or | I can send | have access to the same style map search as patrons, only that |
| restaurants | night | this view allows the person to see different “types” of results, |
| near me | requests | there will be events, musicians, chefs, bars and restaurants. |
| that are | to them. | Chefs and/or musicians can see bars and restaurants in their |
| part of | | search result, using the maps features, they can zoom out and |
| ThreeTo | | results will pop up as the map changes size or position. The |
| Party | | results can be color coded to show the status/availability of the |
| | | restaurant and maybe the type of cuisine. |
| | | clicking/hovering over a search result could show the |
| | | “business card” of a bar or restaurant so that the musician or |
| | | chef can see reviews, number of events hosted and contact the |
| | | restaurant via Facebook, e-mail, telephone, etc. |
| | | the musician and/or chef can send a night request from a |
| | | calendar accessed from the bar and restaurant results. |
| | | (Someday a musician or chef, maybe only elite musicians or |
| | | chefs, can send requests to bars or restaurants on nights not |
| | | marked as “available”. e.g. Chef Ramsay is in LA in such and |
| | | such date.) Initially musicians and/or chefs will be able to see |
| | | in a result the nights when a bar or restaurant is looking for a |
| | | musician or chef to pair with. |
| Receive | I can | I can upload my PayPal account or other relevant monetary |
| payment for | capture my | exchange system so that payment can be deposited for my |
| an event | salary for | services. |
| | a night's | I can register pertinent tax information required for any tax |
| | work | forms or reports we must make at the end of the year. |
| Review a | I can | A musician or chef contributes his own take to a particular |
| particular | provide my | event. How the execution of the menu was, how the ambiance |
| event | input on | and equipment was maintained, how he interprets the patrons |
| | a particular | felt? This could help us provide musicians and chefs with |
| | event. | statistical tests on how close they are to their customers and |
| | | how they are viewed to their peers. |
| | | This could later link to sites such as Pinterest and other |
| | | “foodie/picture/music” sites like Instagram and iTunes to name |
| | | a few . . . Users could use this as a forum to share experiences |
| | | about the music, dishes, drinks and menus. The musician and/ |
| | | or chef can then comment on reviews by user's pictures |
| | | of a menu item, video or audio of the event and post his/her |
| | | own pictures and other media from the event. From these |
| | | type of results, etc. patrons can “like” a chef's Facebook |
| | | profile, follow him/her on twitter, etc. |
| I want my | I can be | once bars, restaurants, musicians and chefs have completed a |
| confirmed | reminded | list of back and forth steps (e.g. the process of buying on eBay |
| event added | of my | lets each user know how far the other user is in meeting the |
| to my | upcoming | requirements. The chef can upload a draft menu and the |
| calendar | event | restaurant can approve the menu. Each time changing the |
| (outlook, | | status of the item. Once all items are “locked” the event can be |
| google, | | confirmed and will now appear in searches, etc. |
| etc.) | | Once the confirmed event is created, the musician and/or chef |
| | | will get an e-mail asking him as a calendar invite with all of the |
| | | confirmation details needed to be a useful e-mail. If the |
| | | musician and/or chef is the one that submits the “ready for |
| | | confirmation” first, then he gets an option on screen like with |
| | | “GoToMeeting” to add the event to my outlook, google |
| | | calendar or forward the invite to a certain e-mail. |
| I want to | my friends | From my profile, I can link my Facebook, twitter, Pinterest, |
| link my | can | foursquare, etc. many if not all social sites have links and APIs |
| activity to | know the | for this. We will need it in order for invites to go out to my |
| social media | event I'm | friends, etc. certain features in the software will have to be |
| (i.e. | hosting | enabled only if social media is linked, others to mobile phone, |
| Facebook, | | others to e-mail . . . etc. |
| twitter, etc.) | | |
| Send a | I can let a | Musicians and/or chefs can, depending on their user level, |
| request to a | bar or | send invites to bars or restaurants. Bars or restaurants (as seen |
| bar or | restaurant | below) can filter the type of invites they are willing to receive. |
| restaurant | know that I | |
| for a night | would like to | |
| | perform on a | |
| | certain night. | |
| See a bar or | I can decide | When reviewing a bar or restaurant's “business card” a |
| restaurant's | if it's an | musician and/or chef can see the tools, kitchen staff (like their |
| kitchen | establishment | profiles either here or in social media), equipment, stage, etc. |
| expertise | I want to | this helps the app tell the whole story. |
| and tools | pair up with. | |
| See if a bar | I can decide | based on outcomes of our algorithm, the musician and/or chef |
| or | based on | can see if a certain bar or restaurant is recommended for my |
| restaurant | inventory, | cuisine style, preferences, experience, etc. |
| is rec- | kitchen staff, | |
| ommended | ratings, etc. | |
| for | my if the | |
| skills | establishment | |
| | is a place I | |
| | would like to | |
| | perform. | |
| As a Chef, I | I can share | my higher-level account can give me access to menu planners, |
| would like | them with | these can help the chef decide on price per dish, tool can help |
| to create | bars and | provide insight as to how much profit the chef and/or |
| my menus | restaurants | restaurant can make. |
| on the | | the chef uses the tool to track his menus, the ingredients, the |
| cloud | | prices, he could eventually link our app to others that help |
| | | chefs plan and document menus, such as whole pantry, cook, |
| | | allrecipes, epicurious, etc. |
| | | later, chefs could request someone to create content through |
| | | our website (e.g. place a menu in a pretty format for a hosted |
| | | wedding.) |
| Have access | I can review | the graphical menu planner is beautiful, deep rich imagery of |
| to my old | old menus | fresh organic beets, fennel, garlic, cutting boards . . . and the |
| menus | I've designed | recipe book is indexed and searchable. Menus can be merged |
| | | together by replacing appetizers, entrees, desert, sorbet . . . |
| | | you name it. Or take individual dishes from a selection, or |
| | | edit an individual dish . . . levels deep edit small, |
| | | edit big and categorize MY menus! |
| | | MY recipes . . . my social media on food!!! |
| Get an | I can get an | My menu editor can tap into local price of produce and |
| estimate of | indication if | ingredients, this way, when designing a menu the chef |
| cost per | the menu is | can learn to be a businessman. |
| person from | right for the | |
| my menu | venue I've | |
| | chosen. | |
| Com- | I can be in | once a pairing is initiated and the bar or restaurant and I are |
| municate | contact with | walking through the steps of invite/accept invite, menus |
| with a | the bar or | exchange, menu review, menu edited, menu agreed upon, |
| bar or | restaurant | seating arrangement settings defined, then the event is |
| restaurant | regarding | confirmed and appears in search for patrons, gets sent as alert |
| regarding an | our planned | for followers of the chef, followers of the restaurant get |
| engagement | event. | notified as well. |
| Com- | I can | The musician and/or chef may communicate to the patrons by |
| municate | communicate | posting on the “comments thread” of the event. My |
| with | my | communications will be badged in a different color so people |
| reserved | ambiance | looking at a thread may identify a post by a musician and/or |
| patrons | and feelings | chef, the restaurant, or other patrons. |
| | regarding | |
| | the event. | |
| Review a | I can provide | As part of the event review from the musician and/or chef's |
| bar or | feedback | perspective the musician and/or chef can score the cleanliness |
| restaurant's | based on a | and conditions of the equipment in the restaurant, the |
| equipment | bar or | collaboration of the bar or restaurant staff, ambiance, etc. |
| | restaurant's | |
| | equipment | |
| | for other | |
| | musicians or | |
| | chefs. | |
| Review a | I can provide | As part of the event review from the musician and chef's |
| bar or | feedback to | perspective the musician and/or chef can score the |
| restaurant's | other chefs | friendliness, skill, etc. for the staff working in the bar or |
| staff | and/or | restaurant. |
| | musicians | |
| | about a | |
| | restaurant's | |
| | support | |
| | during my | |
| | event. | |

As a Patron

| I want to . . . | So that . . . | |
|---|---|---|
| <what> | <why> | It is expected that . . . <acceptance criteria> |
| Register for | I can access | I should be able to provide a payment profile, like PayPal . . . |
| an account | the system | I can add my e-mail, telephone number, availability |
| | | for texts, e-mail offers, contact through social media, etc. my |
| | | profile can be expanded, I can choose to login with Facebook, |
| | | google+ or just through the main website. I can link to my |
| | | Pinterest account, to my Facebook, to my Instagram so that |
| | | pictures that I upload can be posted as part of my review. |
| | | The pictures and comments on reviews can be marked as |
| | | inappropriate by any class of reviewer in which case the |
| | | system administrators will review it and settle the dispute. |
| Search for | I can decide | The patron map is the most filtered but richest result map. |
| events near | if events | Patrons can also choose to see bars and/or restaurants that |
| me | meet my | have been or are part of ThreeToParty so they can access |
| | needs | review of past events and basically just browse for new joints |
| | | to try out (even in regular days wouldn't you want to, as a |
| | | restaurant, appeal to patrons on nights you are NOT hosting a |
| | | ThreeToParty?) |
| | | patrons can also choose to see events differently, by filtering |
| | | cuisine types, date ranges, price ranges, selected chefs, from |
| | | favorite chefs, in favorite restaurants, etc. the search for events |
| | | could be very dynamic maybe you find the absolute perfect |
| | | date you are looking for three months from now, rather than |
| | | the maybe (lame to you) event one week from now |
| Cater my | I can request | Plan an amazing wedding, go on website as a patron and search |
| pre-paid | musicians, | for restaurants, breweries, bars, musicians, bands and chefs |
| event | chefs, bars | that would cater and/or play at my wedding or other special |
| | and | event, create one for my friends, etc.. |
| | restaurants | |
| | to cater my | |
| | event. | |
| Pay for my | I can secure | I want to have a means to prove I've paid for the event. |
| reservation | my place for | Electronic tickets, linked to the bar and/or restaurant POS |
| | the event | system, etc. |
| Cancel my | I can receive | cancelations may occur if a restaurant doesn't meet my dietary |
| reservation | a refund in | needs request, they might also be canceled three weeks before |
| | case my | an event with minimal fees, up to one week before with a larger |
| | plans change | fee and the night before a full forfeit. The bar and/or restaurant |
| | | may choose to serve walk-ins that are hoping for the one |
| | | cancelation from the night before. If this becomes a thing, we |
| | | need to help it become a thing. |
| Have access | I can decide | My search for reviews when seeing a bar, restaurant's, |
| to bar and | if the venue | musicians and/or chef's business cards will show me the |
| restaurant | is one I want | compiled averages for the chef or restaurant. As a patron |
| reviews | to visit | however, I can see or ask to see to read reviews of a certain |
| | | chef/restaurant pairing, if one has occurred in the past it may |
| | | show up as a golden review or something. From the business |
| | | card, the patron can see all events held at a restaurant, |
| | | regardless of the chef. The chef will showcase all events |
| | | he/she has cooked at. |
| Have access | I can decide | As a patron, I can't search for musicians or chefs on the map, |
| to musician | if the chef is | unless they assign themselves to a place of business. I can filter |
| and/or chef | someone | I through city level so that I can see which musicians and/ |
| reviews | want to try | or chefs are willing to operate in San Diego, for example. |
| | or the music | Also, I can choose to see musicians and/or chefs from a |
| | is something | certain city or specific musicians andh/or chefs that I can |
| | I want to | search for presenting events in other geographical areas (if I'm |
| | listen to. | traveling). The patron can access reviews then from the results |
| | | of the musician and/or chef search. can mark comments |
| | | as inappropriate that will trigger review. |
| Review and | I can provide | I will have to access to my past reservations. For future |
| event I've | my feedback | reservations I can cancel or communicate to the bar and/or |
| attended | about the | restaurant. For events I've attended, like the e-bay method for |
| | experience | bars or restaurants. Chefs, and/or also as a patron I will be |
| | | marked on whether I provided feedback or not (i.e. everyone |
| | | wants to be the king of the reviewers not a bad patron, |
| | | competitions on coolest pictures, etc.). Patrons that provide |
| | | feedback get brownie points and get increased karma for |
| | | helping the ThreeToParty network with comments and reviews. |
| | | “future” feedback is not really feedback, its writing on the |
| | | event page of the bar or restaurant, musician and/or chef |
| | | match. In this case, the patrons can communicate, a little like a |
| | | Facebook or 9gag comments thread. Anyone else reviewing |
| | | comments on this page, can mark them as inappropriate, |
| | | triggering actions for review. Bars and restaurants can |
| | | incentivize patrons, for example, by communicating that there |
| | | still are 20 seats to fill and that they'll provide live music if |
| | | you get your contacts to fill the chairs, provide perks, like |
| | | free drinks, etc. |
| Get alerted | I can choose | In my user profile I can provide my communication |
| when an | to attend the | preferences, I must provide a minimum contact information in |
| event is | event. | order to reserve. I must be able to communicate with the host |
| createdin | | bar or restaurant. In order to send dietary requests, and cancel |
| my area | | with fewer penalties, then you should communicate via our |
| (e.g. | | messenger, so that the restaurant can get communicated if a |
| badges/ | | certain customer has a certain type of question. |
| e-mails) | | With this contact information, the website can send |
| | | communication to the patron. If they use our messenger and |
| | | use the badges as reminders to take action then we incentivize |
| | | as seen above. |
| Follow | I can get | I can follow a musician and/or chef on Facebook or other sites, |
| chefs | updates | again, Pinterest, Instagram, and other foodie sites that may |
| on social | from my | have APIs available. Same goes for Facebook to our website. |
| media | favorite | Friends can like a certain restaurant from their Facebook page. |
| | chefs | |
| Follow | I can get | Same goes for bars and restaurants. From a search result, I can |
| restaurants | updates | access the bar or restaurant's website, and I can book a table on |
| on social | from bars or | independently with the bar or restaurant if the event is NOT a |
| media. | restaurants | ThreeToParty exclusive event. |
| Search for | I can review | when looking for an event based on a certain cuisine I as a |
| events by | my options | patron can request that the bar or restaurant, the chef or the |
| cuisine | regarding | combination fall within my parameters of cuisine types. |
| | many cuisine | Imagine a patron actually wants to experience a “what's the |
| | types | worse than can happen . . . ” pairing. The patron actually |
| | | WANTS to experience the Italian sushi. Other more |
| | | traditionally awesome pairings can also get a following. [symbol] |
| Search by | I can tailor | Certain events can be booked as prix fixe menu, small |
| events by | my | appetizer menu, etc. the bar and restaurant, musician and chef |
| price range | experience | can come up with the price per seat. Eventually, the dust will |
| | to my | settle, and the more popular experience will be the most often |
| | current | searched for and paid for reservation type. |
| | budget | |
| Watch an | I can decide | as a patron, when I log into the website, I can access very cool |
| event (add | later if I plan | features, that allow me to schedule ahead, learn more, |
| it to a view | on attending | download menus, see a band's music on the web, etc. |
| list without | the event | additional features that you cannot use if your browsing the site |
| purchasing) | | as a guest. Non-paying guests of the website will get searching |
| | | capability but with substantially less features, no discounts, etc. |
| | | In this particular case, we are talking about adding an event |
| | | to a “watch list” I cannot do this if I'm a guest of the website. |
| Know | I can | my profile as a patron of the website is to see my history, gain |
| which | remember | karma points on reviews, get birthday prizes, obtain discounts |
| bars and | my | on amount of visits, free wine on certain nights, etc. |
| restaurants | experiences | |
| I've been to | and read my | |
| before | reviews from | |
| | that event. | |
| Know which | I can | see the list of events I've been to, filtered by independent |
| chefs I've | remember | chefs, so I can see if I gave the chef high star count or low star |
| experienced | my | count. |
| | experience | |
| | about the | |
| | food | |
| Earn | I can get | You can only earn rewards if you have an account with |
| rewards | rewards such | ThreeToPartyThreeToParty. The more you use the system, the |
| based on | as discounts | more reviews you provide about musicians, chefs, bars, and |
| my use of | codes. | restaurants. The more complete your surveys, the more points |
| the product | | you get. You then get higher level membership by either |
| | | paying a bigger fee or earning it “like airline miles” |
| Get alerted | I can choose | as well, a paying patron can like and follow musicians and/or |
| when my | to reserve | chefs, he/she can track or get alerted when a certain chef is in |
| favorite | that night for | town. Basically the more you pay for your patron account, the |
| musician | an event, | earlier you know if Chef Ramsey is cooking in your city. |
| and/or chef | | |
| is in town | | |
| Get alerted | I can choose | a paying patron can like and follow bars, he/she can track or |
| when my | to reserve | get alerted when a certain restaurant has created an event. |
| favorite bar | that night for | Basically the higher your patron account status, the earlier |
| or | dinner, | you know if “The French Laundry” is hosting, for example. |
| restaurant | | |
| is hosting | | |
| Post my | My friends | as a patron I can log into ThreeToParty with my Facebook |
| activity to | can know the | profile, this way when I like something in my reviews, I can |
| Facebook | event I'm | automatically check in at an event, if I have the mobile app |
| | attending. | version of the website, the GPS can tell me whether I'm |
| | | near a last minute opening. |

As a Venue (i.e. Bar or Restaurant)

| I want to . . . | So that . . . | |
|---|---|---|
| <what> | <why> | It is expected that . . . <acceptance criteria> |
| Upload | Musicians | as a restaurant, I can mark certain dates as “not open for |
| available | and/or chefs | invites”, “dates available”, “chef invited”, “musician invited”, |
| dates at my | can contact | “invite open”. Musician and/or Chef invited means that, from |
| estab- | me for | the calendar, the restaurant sent an invitation to a musician |
| lishment | booking | and/or chef to participate in an event. Invite open means that a |
| | | musician and/or chef can send an invite to connect and the |
| | | restaurant will consider the invite, at this point, the restaurant |
| | | can set defaults on a day or range of dates marked invite open, |
| | | so that they can choose the musicians and/or chef or chefs of |
| | | choice for certain dates, they can also block out a certain |
| | | cuisine, music genre, etc. that can be seen by musicians and |
| | | chefs as a requirement to invite the restaurant on such date. It |
| | | makes an effective negotiation tool. |
| Send invites | I can let a | Bar or Restaurant can search for a musician and/or chef(s) |
| to musicians | musician | based on certain criteria. They can choose to search/filter by |
| and/or | and/or chef | availability dates, but they can also just choose to see all |
| chefs for an | know that I | musicians and/or chefs, this allows the bar or restaurant to |
| event | would like to | invite the musician and/or chef on a date not marked as |
| | book | “unavailable” by the chef. Restaurants may not send invites to |
| | him/her for a | chefs that have blocked invitations, this would allow chef |
| | certain date | Mario Batali, for example, who would honor any restaurant, to |
| | | decide where to cook. Chef Batali however can elect to allow |
| | | certain restaurants to invite, as friendly restaurants, etc. |
| | | as mentioned in the musician and chef section, the bar and |
| | | restaurant page will have like an e-bay type interface that |
| | | allows the musicians, chef and restaurants know when a certain |
| | | task is complete. Events need to be confirmed, we can track |
| | | analytics of how long a certain chef take on average to |
| | | complete certain steps. Bars and Restaurants that have a high |
| | | level membership can see a musician and/or chef's |
| | | performance measures, for reviews. Musicians and/or Chefs |
| | | that don't want to provide this data can opt out. However, |
| | | restaurants will know which chefs aren't afraid of showing |
| | | their performance. Same goes for chefs that have |
| | | an elite status with us. |
| See chefs | I can send | same as with the results on bars and restaurants, when a |
| near me | event | musician or chef searches, the bars and restaurants can see |
| that are | requests to | musicians and chefs that have allowed their activity to be |
| part of | them. | tracked, the chef will only be listed as willing to travel x miles |
| ThreeTo | | from a certain intersection or something so they can't be |
| Party | | located using our app (like HIPPAA does for de- |
| | | identifying data) once I see the results from the musician |
| | | or chef search I can open to see a musician |
| | | and/or chef's profile and go to his availability calendar. |
| See a | I can decide | Probably already has been covered, but when searching for a |
| musician | if he/she is a | musician and/or chef, the business cards will be shown and can |
| and/or | musician or | be expanded. The business card of the musician and/or chef |
| chef's | chef I want | can contain reviews (the section of all event reviews that |
| expertise, | to try out. | scores the chef, these are not optional) patron facing ratings are |
| cuisine of | | not optional for musicians, chefs, bars or restaurants. This |
| choice, | | app faces and is designed to cater to patrons, as they are the |
| music | | customers with the money and the observers of art. Chefs, |
| genre, etc. | | musicians, bars and restaurants and ThreeToParty . . . |
| | | all are tools enabling this dream to come true. |
| | | from this search, I can choose to mark a certain musician or |
| | | chef as “accept invites from this chef” for example, a restaurant |
| | | may accept invites from “Michelin star chefs” or a certain level |
| | | of chef (e.g. level 1 or elite) in this case, chefs don't have a |
| | | choice the restaurant provides the investment and the means |
| | | for patrons to dine. The chef is being provided a forum and |
| | | restaurants have the say on invites. |
| Com- | I can provide | from my events page, I can go and track how many tables have |
| municate | updates | been reserved, the configuration of the tables, my calculated |
| with | regarding | profit and ROI with the current number of seats reserved, |
| reserved | their | eventually show the statistics of how many people “liked” the |
| patrons | reservation. | event on FB, how many people added as favorite but never |
| | | reserved, how many people canceled. This data can and will |
| | | be used as analytics . . . |
| | | I can communicate with patrons that reserved. Maybe in a |
| | | graphical format I can seat them so that my hostess for the |
| | | evening will have a seating chart at her disposal. I can send an |
| | | e-mail to a patron or the entire list of attendees. I can answer |
| | | questions a certain patron may have. The patron will need to |
| | | mark the communication as a request, general question, |
| | | comment or dietary request. If the restaurant can't confirm the |
| | | dietary request of the patron, the patron may choose to cancel |
| | | the reservation with no penalty, or the restaurant may |
| | | (probably never will) cancel the reservation of the patron for |
| | | some given concern. (i.e. right to refuse service) |
| Receive | I can capture | I can upload my PayPal account so that we can deposit money |
| payment | the revenue | to the bar or restaurant. |
| for | from a | I can register pertinent tax information required for any tax |
| an event | planned | forms or reports we must make at the end of the year. |
| | event | |
| See events | I can plan an | The bar or restaurant has the ability of seeing the map as a |
| near me | event | date patron sees it, as a musician or chef sees it or as intended |
| | based on | for a bar or restaurant. By showing events booked by date or |
| | other | musicians and/or chefs near me with a certain cuisine, music |
| | existing | genre, expertise and culinary experience. Or by showing other |
| | events | restaurants that are part of ThreeToParty, this allows a bar or |
| | | restaurant to see if a competitor has blocked out a certain date |
| | | and take advantage of hosting that night. Rather than a |
| | | competitive tool this can be sold as a means to negotiate. |
| Review a | I can provide | I have the ability of contributing to the review process of an |
| musician or | feedback | event. Events that are reviewed by patrons, musicians, chefs |
| chef's | based on a | bars and restaurants get color coded on the review section of |
| performance | musician | the events. This allows people to know who has reviewed the |
| at my | and/or chef's | event, pressuring everyone to provide feedback and reviews! |
| estab- | performance | |
| lishment | and | |
| | contribute to | |
| | his overall | |
| | status. | |
| I want my | I can be | As mentioned in the musician and chef section, either the bar |
| confirmed | reminded | of or restaurant or the musician and/or chef may be the first one |
| event added | my | to finish the event planning process. Bars and restaurants and |
| to my | upcoming | musicians and/or chefs will be presented the wizard allowing |
| calendar | event | us to expand functionality, for musicians, chefs, bars and |
| (outlook, | | restaurants, at a point in time, chefs and restaurants may only |
| google, | | want to deal with users that have higher level accounts. This is |
| etc.) | | because the tools presented to elite customers, makes the |
| | | transaction easier. One example is the menu builder, the |
| | | seating optimizer, the revenue planner, etc. tools that are |
| | | meant as business productivity tools for the industry. |
| Open | I can book a | a bar or restaurant may see invites from musicians and/or |
| availability | night based | chefs that appear as part of the results |
| on my | on a request | |
| calendar | from a | |
| based on a | musician | |
| musician | and/or chef. | |
| and/or | | |
| chef's | | |
| request | | |
| See if a | I can get help | based on a chef's cuisine, expertise and other factors, the site |
| musician | deciding if | can offer a suggestion if the musician, chef, bar and/or |
| and/or chef | we make a | restaurant make a nice fit. Some bars and restaurants may opt |
| is rec- | good pair. | for “going for it” by choosing musicians and/or chefs that fall |
| ommended | | on the “what the heck . . . what's the worst that can happen” |
| for my | | side of reality. Other bars and restaurants may prefer musicians |
| estab- | | and chefs that fall into the “made for each other” category. |
| lishment. | | In which case a safe, potentially brilliant combination is |
| | | made. This scale tips both ways and there is no negative |
| | | connotation to being an Asian chef in an Italian restaurant! |
| Receive a | I know what | knowing the seating arrangements, waste (calculated by |
| shopping | to order for | product type. i.e. there has to be more wasted lettuce than |
| list based | the | beef.) the restaurant gets a shopping list, even a virtual one of |
| on the | scheduled | things needed for the night. The people in the restaurant might |
| proposed | night. | end up removing some items that are already in stock. |
| menu from | | |
| the chef | | |
| List of | I know what | when designing a menu, the chef may select tools that are |
| equipment, | to plan for | special and usually not played with (like nitrogen), then in the |
| prep and | and prep for | menu submittal/review process the chef will receive |
| staff | a given night. | confirmation of tool availability or alerted that a certain tool is |
| needed | | either unavailable or the restaurant doesn't own it (based on |
| based on | | inventory from restaurant “business card”) in this case, |
| the menu. | | the chef may edit the menu. Confirm that he/she can provide |
| | | the tool or cancel the pairing request. |
| Calculate | I can plan for | As seats are booked for a confirmed event, I can see the ROI |
| my profit | marketing | based on purchases for menu, operation and staff costs, etc. I |
| based on | my event | know whether I should print out some fliers, use Facebook to |
| filled seats | less or more | promote myself, etc. elite level accounts for restaurants get this |
| | using social | automated service for free! The software will calculate a time |
| | media. | in which invites to people looking or send a discount to people |
| | | that have “liked” the event but not booked a reservation. |

VII. Multivariate Statistical Analysis

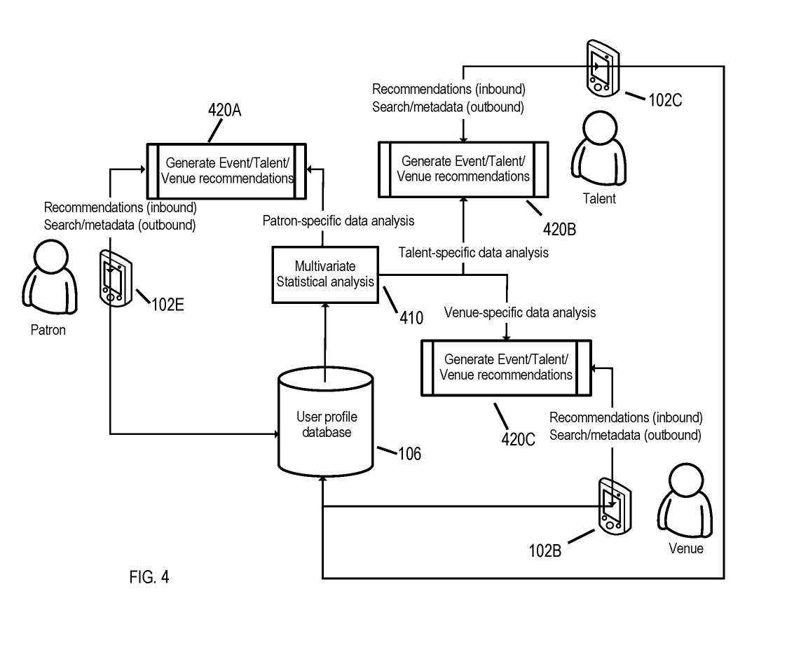

FIG. 4 is a flow diagram illustrating an example process for multivariate statistical analysis that may be used in connection with various embodiments described herein. In an embodiment of the multivariate statistical analysis, data may be collected from one or more of the processes described herein and analyzed—potentially in conjunction with industry knowledge—to improve users' experiences. For example, a users' profile information, previous purchases, previous participations, events, venues, or talent that the user has indicated a propensity towards (e.g., by posting a “like” or other favorable review for the event, venue, talent, cuisine type of the talent, music genre of the talent, etc.), previous purchase patterns, other available purchase history (e.g., from third-party sources), and/or the like may be analyzed and used to improve the matching of talent and venues and/or events and potential patrons (e.g., in order to provide future event recommendations). Results may also be used to provide valuable industry insight by analyzing data as an aggregate (e.g., across multiple events, patrons, talent, and/or venues) and using the conclusions of that analysis to further improve future recommendations.

As illustrated in FIG. 4, each venue device (e.g., 102B), talent device (e.g., 102C), and patron device (e.g., 102E) can communicate with a platform comprising user profile database 106 and a multivariate statistical analysis module 410. Specifically, each device 102 may search user profile database 106 (e.g., search user profiles and/or metadata corresponding to user profiles). Recommendations 420, based on user-defined searches and/or automated (e.g., periodic) analysis and matching, may be returned by multivariate statistical analysis module 410 to each of the devices 102. For example, recommendations 420A regarding one or more upcoming events which may be of interest to a patron may be provided to patron device 102E, recommendations 420B regarding one or more potential venues may be provided to talent device 102C, and recommendations 420C regarding potential talent may be provided to venue device 102B. It should be understood that communications between the various devices 102 and the platform (e.g., user profile database 106 and multivariate statistical analysis module 410) may be performed over one or more networks (e.g., the Internet) using standard communication protocols.

As an example analysis, multivariate statistical analysis module 410 may review a profile for a restaurant venue. The profile may include or reference a list of prior events, involving talent, that have occurred at the restaurant and a list or number of patrons who attended those events. Multivariate statistical analysis module 410 may review the list of prior events and attending patrons to determine characteristics of events that were successful (e.g., a large number of attending patrons, a large percentage of accepting patrons to invited patrons, a large profit, etc.) and characteristics of events that were unsuccessful or less successful (e.g., a low or lower number of attending patrons, a lower percentage of accepting patrons to invited patrons, less or no profit, etc.). From this, multivariate statistical analysis module 410 may determine a correlation between specific characteristics (e.g., cuisine type, music genre, specific menu item, time of event, etc.) and the success or lack of success of events at the particular venue. These correlations may then be used in the future to identify events which are more likely to be successful (e.g., having a cuisine type, music genre, specific menu item, or time of a previously successful event). Only events which have a likelihood of success (e.g., as indicated by the ranking or score discussed elsewhere herein) above a predetermined threshold may be recommended to the venue, or events may be ordered or otherwise prioritized (e.g., in search results) based on the determined likelihood of success.

Similarly, multivariate statistical analysis module 410 may review a profile for a talent (e.g., chef or musician). The profile may include or reference a list of prior events, in which the talent participated, and a list or number of patrons who attended those events. Multivariate statistical analysis module 410 may review the list of prior events and attending patrons to determine characteristics of events that were successful (e.g., a large number of attending patrons, a large percentage of accepting patrons to invited patrons, a large profit, etc.) and characteristics of events that were unsuccessful or less successful (e.g., a low or lower number of attending patrons, a lower percentage of accepting patrons to invited patrons, less or no profit, etc.). From this, multivariate statistical analysis module 410 may determine a correlation between specific characteristics (e.g., cuisine type, music genre, specific menu item, time of event, etc.) and the success or lack of success of events for the particular talent. These correlations may then be used in the future to identify events which are more likely to be successful (e.g., having a cuisine type, music genre, specific menu item, or time of a previously successful event). Only events which have a likelihood of success (e.g., as indicated by the ranking or score discussed elsewhere herein) above a predetermined threshold may be recommended to the talent, or events may be ordered or otherwise prioritized (e.g., in search results) based on the determined likelihood of success.

As another example, multivariate statistical analysis module 410 may review a profile for a potential patron. The profile may include or reference a list of prior events, in which the patron participated or to which the patron was invited. Multivariate statistical analysis module 410 may review the list of prior events to determine characteristics of events that were or were not of interest to the patron. From this, multivariate statistical analysis module 410 may determine a correlation between specific characteristics (e.g., cuisine type, music genre, specific menu item, time of event, location of event, venue of the event, talent involved, etc.) and the events to which the patron accepted and/or declined invitations. These correlations may then be used in the future to identify events in which the patron is more likely to be interested, and therefore, to which the patron is more likely to accept an invitation. Only events which have a likelihood of acceptance (e.g., as indicated by the ranking or score discussed elsewhere herein) above a predetermined threshold may be recommended to the patron, or events may be ordered or otherwise prioritized (e.g., in search results) based on the determined likelihood of acceptance.

VIII. Computer-Enabled Embodiment

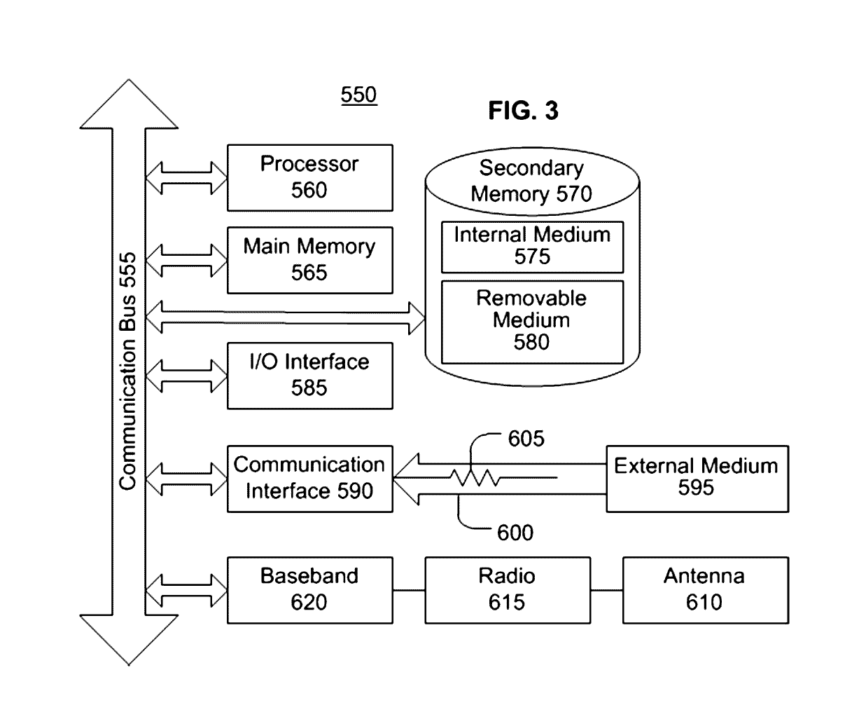

FIG. 3 is a block diagram illustrating an example wired or wireless system 550 that may be used in connection with various embodiments described herein. For example the system 550 may be used as or in conjunction with a system for matching chefs, musicians, bars, restaurants and customers to create exclusive events, as previously described with respect to FIGS. 1-2. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising using at least one hardware processor to:
create a plurality of talent profiles, wherein each talent profile comprises information for a talent;
create a plurality of venue profiles, wherein each venue profile comprises information for a venue;
compare information in one or more of the plurality of talent profiles to information in one or more of the plurality of venue profiles to identify at least one match between a first talent and a first venue;
generate a representation of an event based on the at least one match between the first talent and the first venue, wherein the event comprises at least one action performed by the first talent at the first venue;
identify one or more potential patrons of the event; and
invite the one or more potential patrons to the event.

2. The method of claim 1, further comprising creating a plurality of patron profiles, wherein each patron profile comprises information for a potential patron, wherein identifying one or more potential patrons of the event comprises comparing information in the representation of the event to information in one or more of the plurality of patron profiles to identify at least one match between the event and a patron.

3. The method of claim 2, wherein each of the one or more patron profiles comprises a reference to reviews previously posted by the respective potential patron, and wherein comparing information in the representation of the event to information in one or more of the plurality of patron profiles comprises comparing information in the representation of the event to information extracted from the reviews previously posted by each respective potential patron.

4. The method of claim 2, wherein each patron profile comprises a location of the potential patron, wherein the representation of the event comprises a location of the event, and wherein identifying one or more potential patrons of the event comprises comparing the location of the one or more potential patrons to the location of the event.

5. The method of claim 1, wherein generating a representation of an event based on the at least one match comprises:
providing the at least one match to both the first talent and the first venue;
receiving an acceptance of the at least one match from the first talent;
receiving an acceptance of the at least one match from the first venue; and,
after the acceptance has been received from both the first talent and the first venue, generating the representation of the event.

6. The method of claim 5, wherein the venue profile for the first venue comprises a location of the first venue, wherein comparing information in one or more of the plurality of talent profiles to information in one or more of the plurality of venue profiles comprises analyzing a schedule of a talent profile for the first talent to identify a time period in which the first talent will be within a geographical vicinity of the location of the first venue, and wherein providing the at least one match to both the first talent and the first venue comprises recommending the identified time period for the event to the first talent and the first venue.

7. The method of claim 1, further comprising facilitating planning or completion of the event.

8. The method of claim 7, wherein facilitating the planning or completion of the event comprises identifying a time period for the event based on a schedule of the first talent and a schedule of the first venue.

9. The method of claim 8, wherein the schedule of the first talent is comprised in the talent profile for the first talent, and wherein the schedule of the first venue is comprised in the venue profile for the first venue.

10. The method of claim 1, further comprising receiving one or more reviews of the event from one or more attending patrons.

11. The method of claim 1, wherein the first talent is a chef.

12. The method of claim 11, wherein the talent profile for the chef comprises a cuisine type.

13. The method of claim 11, further comprising facilitating planning of the event by providing a menu-generating user interface to the chef, and receiving a menu from the chef via the menu-generating user interface.

14. The method of claim 1, wherein the first talent is a musician.

15. The method of claim 14, wherein the talent profile for the musician comprises a music genre.

16. The method of claim 1, wherein the first venue is a restaurant, bar, or food truck.

17. The method of claim 1, wherein each of the one or more potential patrons of the event are identified based on a membership level, and wherein the membership level increases based on a prior participation of the potential patron in a previous event.

18. The method of claim 1, further comprising:
receiving an acceptance of the event from one or more of the one or more invited potential patrons;
receiving payment for attendance of the event from the one or more accepting patrons; and
creating a reservation, for the one or more accepting patrons, to attend the event.

19. A system comprising:
at least one hardware processor; and
at least one software module configured to, when executed by the at least one hardware processor,
create a plurality of talent profiles, wherein each talent profile comprises information for a talent,
create a plurality of venue profiles, wherein each venue profile comprises information for a venue,
compare information in one or more of the plurality of talent profiles to information in one or more of the plurality of venue profiles to identify at least one match between a first talent and a first venue,
generate a representation of an event based on the at least one match between the first talent and the first venue, wherein the event comprises at least one action performed by the first talent at the first venue,
identify one or more potential patrons of the event, and
invite the one or more potential patrons to the event.

20. A non-transitory computer-readable medium having instructions stored thereon, wherein the instructions, when executed by a processor, cause the processor to:
create a plurality of talent profiles, wherein each talent profile comprises information for a talent;
create a plurality of venue profiles, wherein each venue profile comprises information for a venue;
compare information in one or more of the plurality of talent profiles to information in one or more of the plurality of venue profiles to identify at least one match between a first talent and a first venue;
generate a representation of an event based on the at least one match between the first talent and the first venue, wherein the event comprises at least one action performed by the first talent at the first venue;
identify one or more potential patrons of the event; and
invite the one or more potential patrons to the event.
